(19) United States
(12) Patent Application Publication
(10) Pub. No.: US 2026/0225209 A1
(43) Pub. Date: Aug. 6, 2026

(54) Magnetic Socket

(71) Applicant: Felipe Ferrer Monroe, Vacaville, CA (US)

(72) Inventor: Felipe Ferrer Monroe, Vacaville, CA (US)

(21) Appl. No.: 19/043,491

(22) Filed: Feb. 2, 2025

(51) Int. Cl. B25B 13/06

(52) U.S. Cl. CPC B25B 13/06

(57) ABSTRACT

The disclosure relates to a magnetic socket wrench that incorporates one or more magnetic members, which are embedded flush within the inner lower surface of the cylindrical body wall of the socket wrench. The magnetic members attract and prevent the nuts/bolts from falling from the socket wrench into machinery. The retention is accomplished when the magnetic members contact the nuts/bolts placed within the socket wrench. The magnetic members are spaced equidistant and adhesively bonded flush within the cylindrical body to facilitate a strong magnetic attraction.

### FIELD OF INVENTION

The present invention relates to the field of hand tools and more particularly, to ratchet wrench socket attachments and the removal of nuts/bolts from an automobile engine.

### BACKGROUND

The repair and disassembly of an automobile engine involves the removal of nuts/bolts and spark plugs. Typically the tool of choice is the air impact or hand held ratchet wrench tool with socket wrench attachments. It has proven to be very challenging for most mechanics to service an automobile engine having difficult areas to access nuts/bolts. Sometimes getting a tool up next to the nut/bolt proves nearly impossible due to the nut/bolt placement. It may be recessed into a tight compartment or blocked by an engine component. During removal, if the ratchet and socket wrench tool attachtment is tillted at an improper angle, the nut/bolt can fall out of the socket wrench into the automobile engine. As such, a need exists for a hand tool to facilitate the removal of nuts/bolts from these difficult areas. The present invention addresses this need.

### SUMMARY OF THE INVENTION

As discussed in the Background information, it has proven to be very difficult for mechanics to install or remove nuts/bolts from hard to access areas when servicing an automobile engine. Part of the difficulty is that the nuts/bolts won't stay secure within the socket wrench during installation or removal. The present invention provides for easy retrieval and the capture of nuts/bolts. The magnetic socket wrench includes a cylindrical body that includes a central bore that extends the axial length of the body. The removal end includes an inner surface having at least one embedded magnet member for use in attracting and securing nuts/bolts within the socket wrench during the removal process.

### PROBLEMS WITH ORDINARY RATCHET WRENCH SOCKETS

The standard ratchet tool socket wrenches are used to install or remove multiple sizes and types of nuts/bolts, primarily from machinery. Socket wrenches fit over nuts/bolts and a ratchet wrench tool engages the socket wrench to allow the user to rotate the nut/bolt on or off.

The nut/bolt is held in place in the socket wrench by friction and leverage. During the installation or removal of a nut/bolt, if the socket wrench is worn or the angle of the ratchet and socket wrench held by the user is not proper, the nut/bolt can fall out of the socket wrench.

This design has limitations and creates the possibility of nuts/bolts falling into machinery and damaging equipment, or extending service time and repair cost of machinery.

### PROPOSED SOLUTIONS FOR ORDINARY RATCHET WRENCH SOCKETS

### Description of the Prior Art

Method 1. The most popular solution put forth in order to deal with this natural limitation inherent in the ordinary ratchet socket wrench design, has been the adaptation of crude methods of holding nuts/bolts in a socket. Most automobile mechanics will apply a heavy lube grease to the inner surface of the removal end of the socket wrench. The expectation is that the nut/bolt will stick in the lube grease within the socket during removal or installation. However there is no guarantee the nut/bolt will stay secure within the socket wrench. This method is hazardous, messy and requires cleanup afterwards.

Method 2. Another solution, and not nearly as popular, is to add a piece of plastic film to the inner surface of the removal end of the socket wrench. The plastic material will cause friction and hold the nut/bolt in the socket wrench. The issue with this method is the plastic material could fall into the automobile engine and wedge between an engine component. If the plastic material is not removed promptly it can cause a fire when the engine is put into service.

Method 3. Another approach to addressing this problem was by adding a synthetic rubber cushioning, or plastic material embedded with magnets to the upper inside of the socket wrench. The problem with this design is the rubber or plastic material is a frictional fit and dependent on a coercive force between the magnet and metal socket. The placement of the rubber cushion or plastic material is too far into the cavity of the socket and creates a problem with the magnets reliably contacting and securely holding the nuts/bolts. When the rubber or plastic material cracks or hardens with age, it falls out of the socket wrench, shortening the life-span of the tool.

It most be noted, that one of the most important requirements of a socket wrench is to hold a fastener securely within the socket wrench, without it falling back into an automobile engine or other machinery. This system as put forth fails to recognize those demands.

Reference U.S. Pat. Nos. 2,551,553, 2,806,396, 5,259,278, 2,551,553

### THE OBJECTIVE

It is the object of this invention to provide a nut/bolt socket wrench that is more reliable than the conventional nut/bolt socket wrench. Most industry ratchet socket wrench sets include both metric and (S.A.E.) Society of Automotive Engineers standard sizes and shapes to fit a large variety of nuts/bolts, commonly referred to as fasteners. Fasteners are held within a socket wrench by friction and the angle of the socket wrench. If a socket wrench loses its friction due to the environment in which grease or oil are present, it can no longer hold a fastener securely in the socket wrench. The fastener will slip out of the socket wrench and could fall into machinery and cause catastrophic failure.

The goal of this invention is to design a ratchet socket wrench to prevent nuts/bolts, fasteners from falling out of socket wrenches into machinery. To reduce the risk of nuts/bolts; fasteners falling into automobile engines, causing damage and to safely remove nuts/bolts; fasteners.

### THE SOLUTION

The present invention the magnetic socket wrench will use magnets to attract and hold nuts/bolts during installation or removal on an automobile engine. The socket wrench cylinder includes an inner surface having at least one embedded magnet member for use in attracting and securing the nuts/bolts within the socket wrench.

### BRIEF DESCRIPTION OF DRAWINGS

FIG. 1 is a perspective view of a spark plug ratchet socket wrench constructed and arranged in accordance with the principle of the invention;

FIG. 2 is the bottom view of the socket wrench cavity of FIG. 1.

FIG. 3 is a top perspective view of the invention.

FIG. 4 shows a longitudinal half-sectional view of the present invention.

### DESCRIPTION OF THE PREFERRED EMBODIMENTS

Turning now to the drawings, in which like reference characters indicate corresponding elements throughout the several views, attention is first directed to FIGS. 1-4 in which there is seen a magnetic socket wrench 10. The socket wrench is preferably formed of metal, or other chosen material or combination of materials having inherently rigid, resilient, and fluid-impervious material characteristics and shaped as a cylinder 11, consisting of two parallel circular bases 12 and 13, joined by a curved surface. Inner surface 14 having a magnetic material 15 embedded, in the lower edge 17, or any preferable area of the cylinder 11. The inner surface 14 is generally “hexagonal” configuration in this example, and can be provided in other chosen shapes, such as “twelve point”, or any other chosen shape or size to fit all metric and (S.A.E.) size nuts/bolts to attain the desired objective.

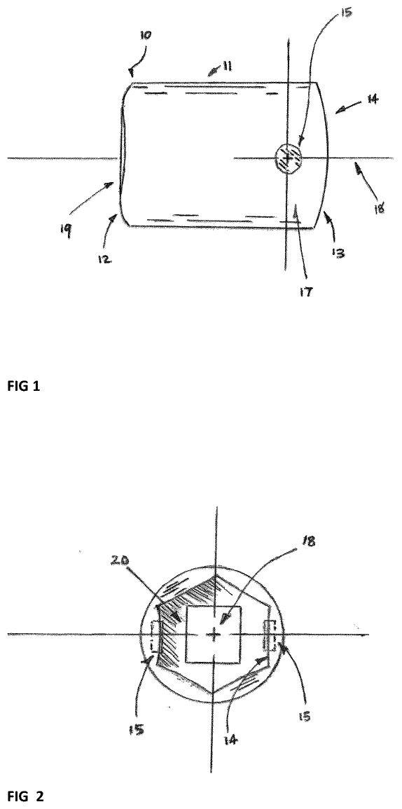

Referring to FIG. 1 socket wrench 10 is specifically intended for the removal or installation of nuts/bolts from an automobile engine or machinery. As will be described, the magnetic material 15 cooperates with inner surface 14 of cylinder 11 to form or otherwise establish a receiver area 14 to enable the capture and easy removal of nuts/bolts. The upper edge 19 engages with a ratchet tool ¼ inch, or ⅜ inch square drive to facilitate the removal of nuts/bolts. As shown in FIG. 1 and 2, the socket's cylindrical body 11 further includes a central bore 18 that extends the axial length of the body 11.

FIG. 2 shows the socket wrench viewed from the bottom end 17, containing a cavity 20 for receiving fasteners such as nuts/bolts for installation or removal from machinery. For example the socket wrench 10 inner surface 14 fits over metric and (S.A.E.) size nuts or bolts. The upper edge 19 square bore engages with a ratchet tool ¼ inch, or ⅜ inch square drive to facilitate the removal of nuts/bolts by the user. The inner surface 14 is generally “hexagonal” configuration in this example, and can be provided in other chosen shapes, such as “twelve point”, or any other chosen shape, size or length to fit all metric and (S.A.E.) size nuts/bolts to attain the desired objective.

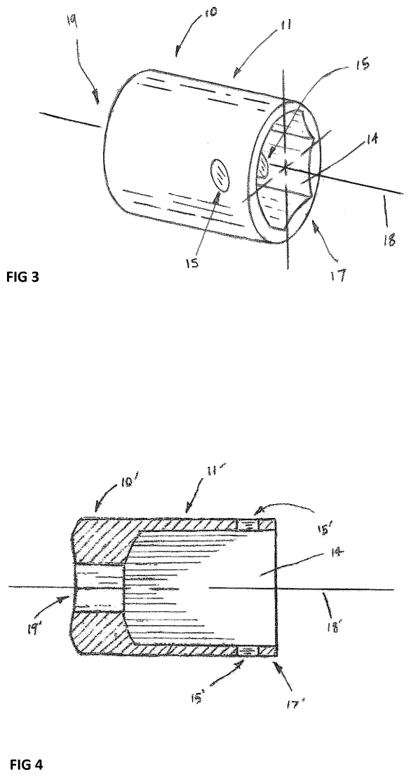

Attention is now directed to FIG. 3, in which there is seen an alternate embodiment from a perspective view of the socket wrench. In common with a non-magnetic socket wrench, the magnetic socket wrench 10, shares a cylinder shape 11, a central bore 18 that extends the axial length of the body, a inner surface 14 and has at least one or two embedded magnetic members 15 thereon, that is preferably a substanially cylindrical shape which faciliates a magnetic attraction and securing the capture of nuts/bolts from a automobile engine.

In accordance with the present invention, at least one magnet member 15 may be any suitable magnet having a sufficient strength for holding nuts/bolts. It is possible different strength magnets could be used for different applications. Specific types of magnets are well known to the person of ordinary skill in the art. At least one magnet 15 is preferably secured to the inner surface 14 by an adhesive.

The magnets 15 used for the socket are cylindrical magnets inserted equidistant from one another in the removal end and lower edge 17. The magnets 15 are flush with the inner surface 14 so that nuts/bolts can fit within the socket wrench and be secured.

To summarize the main features of the magnetic socket wrench, one end of the socket wrench includes an axial cavity and at least one embedded magnet that is sized for fitting in the inner surface of the lower edge, to facilitate the nuts/bolts attraction at the removal end of the socket. The axial cavity is sized in accordance with varying metric and (S.A.E.) sizes so in application it allows the embedded magnet to recieve and hold nuts/bolts of various sizes. The other end of the socket utilizes a square bore, ¼ inch, or ⅜ inch that attaches to an air impact tool or ratchet wrench tool, with or without extention to use in the application of nuts/bolts removal as described in this specification.

The socket wrench body is preferably made from metal, or other material or combintion of materials having inherently rigid, resilient, and fluid-impervious strong material characteristics known in the art to carry out the described objectives.

As mentioned above, the current invention addresses the problems associated with accessing and safely securing nuts/bolts for removal or installation when performing service on an automobile engine. The utility of the present invention is directed to metric or (S.A.E.) socket wrench tool attachments for enabling the easy removal of nuts/bolts.

Use of the magnetic socket wrench attachment as shown in the drawings is as follows: The user attaches the socket upper edge 19 to the drive of a air impact tool, or ratchet wrench tool and places the socket wrench lower edge 17 over the nuts/bolts, so that it is received within the axial cavity 20, and the magnetic members 15 are in contact with the nuts/bolts. The magnetic force of attraction from the magnetic members 15 will hold the nuts/bolts as the socket wrench is upwardly withdrawn from the automobile engine. The user can then safely remove the nuts/bolts from the socket wrench by hand. The time of removal typically taking less than a few minutes to perform.

The socket wrench will be available in different diameters to accommodate all popular metric and (S.A.E.) size nuts/bolts. As previously described the inner surface having at least one magnet member 15′ thereon, is preferably a substantially configuration that defines an attraction surface for securing the easy removal and retention of nuts/bolts from an automobile engine.

At least one magnet 15′ is preferably secured to the inner surface 14′ by an adhesive. The magnets 15′ used for the socket wrench are cylindrical magnets inserted equidistant from one another in the removal end and lower edge 17′. The magnets 15′ are flush with the inner surface 14′ so that nuts/bolts can fit within the socket and be retained. The upper end 19′ of the socket wrench utilizes a square bore, ¼ inch, or ⅜ inch that attaches to a air impact tool or ratchet wrench tool, with or without extention to use in the application of nuts/bolts removal as described in this specification.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent compositions and methods. For example, the application given described the present socket attachment primarily for being used to remove nuts/bolts from an automobile engine. However, it should be understood from the descripton given that the socket attachment can be used for removing nuts/bolts and the like in other applications such as, but not limited to, an automobile engine.

As such, it will be obvious to those skilled in the art that modifications may be made to the embodiments described above without departing from the scope of the invention. Thus the scope of the invention should be determined by the claims in the formal application and their legal equivalents, rather than by the examples given.

What is claimed is:

1. A magnetic socket which comprises a cylindrical body having a first end dimensioned and configured for cooperation with an associated ratchet wrench tool and a second end dimensioned and hexagonal configured for engagement with nuts/bolts, said second end including one or more embedded magnets disposed in the cylindrical body to retain nuts/bolts within said second end, for meshing engagement with nuts/bolts whereby rotation of the socket causes rotation of the nuts/bolts.

2. The socket as described in claim 1 wherein each of said magnets is axially equidistant and has a geometric axis.

3. The socket as described in claim 1 wherein the axis of each magnet is parallel to every other axis of every other magnet in said socket.

4. The socket as described in claim 1 wherein each of said magnets is cylindrical.

5. The socket described in claim 1 wherein each of said magnets is axially magnetized.

6. The socket as described in claim 1 wherein each magnet is parallel to every other magnet and each has a north and a south pole and the physical orientation of each north and south pole is identical.

7. The socket as described in claim 1 wherein each of said magnets is manufactured of neodymium and adhesively bonded flush within the cylindrical body of the socket wall.
